(19) United States
(12) Patent Application Publication
(10) Pub. No.: US 2013/0047210 A1
(43) Pub. Date: Feb. 21, 2013

(54) Systems and Methods for Providing Security When Accessing a User Account of a Browser-Based Communications Application

(71) Applicant: Mark Philip Rotman, Oakville (CA)

(72) Inventor: Mark Philip Rotman, Oakville (CA)

(21) Appl. No.: 13/371,512

(22) Filed: Feb. 13, 2012

Related U.S. Application Data
(60) Provisional application No. 61/442,357, filed on Feb. 14, 2011.

(51) Int. Cl. G06F 21/00

(52) U.S. Cl. 726/3

(57) ABSTRACT

The embodiments described herein provide in one aspect, a method of providing security when accessing a user account of a browser-based communications application, the method comprising: providing a communications server, the communications server configured to access personal information management (PIM) data for the user account, the PIM data comprising a plurality of non-security data items; receiving, at the communications server, a connection request from a remote system, the connection request comprising at least one connection parameter of the remote system; determining if the at least one connection parameter of the remote system is acceptable based on at least one non-security data item of the plurality of non-security data items; allowing access to the user account based on said determining; and sending security awareness data for the user account from the communications server, the security awareness data comprising at least one second non-security data item of the plurality of non-security data items.

### CROSS-REFERENCE TO RELATED APPLICATIONS

This application claims priority to U.S. provisional patent application No. 61/442,357, filed Feb. 14, 2011, the entire contents of which are hereby incorporated by reference.

### FIELD

The described embodiments relate to methods and systems for providing security when accessing a remote application. More particularly, the embodiments relate to methods and systems for providing security when accessing a user account of a browser-based communications application.

### BACKGROUND

When accessing a communications application through a web browser, a user may typically be required to enter a user name and password to authenticate the user. Although authentication aims to prevent unauthorized access, security attacks may still be possible. Some such attacks may include:

phishing—when a user is tricked into entering logon credentials on a web application masquerading as the web application the user is desiring to log on to;

man in the middle—when a user is tricked into connecting to an intermediary, which in turn connects to the actual web application—the attacker may then eavesdrop on the transmitted data and/or may gain future access to the user's account;

brute force, dictionary—when an attacker attempts to repeatedly guess (often in an automated way) the username and/or password combination of a user's account;

key loggers, screen scraper—when a malicious program may be installed on a user's computer and the malicious program captures key strokes or information entered by the user; and

replay attacks—when valid authentication sequences captured in a man in the middle attack (above) or a key logger/screen scraper attack (above) are repeated by a malicious party to gain unauthorized access to a user's account.

Existing measures address these vulnerabilities typically by protecting the communications channel (e.g., through anti-virus scanning and/or packet inspection) or by protecting the security credentials (e.g., through two-factor authentication such as RSA SecurID® to supplement the password). However, these mechanisms have shortcomings. For example, an anti-virus scanner may continually need to be updated for new emerging threats, and two-factor authentication may be susceptible to a man-in-the-middle attack.

There is thus a need for improved methods and systems for providing security when accessing a user account of a browser-based communications application.

### SUMMARY

The embodiments described herein provide in one aspect, a method of providing security when accessing a user account of a browser-based communications application, the method comprising:
(a) providing a communications server, the communications server configured to access personal information management (PIM) data for the user account, the PIM data comprising a plurality of non-security data items;
(b) receiving, at the communications server, a connection request from a remote system, the connection request comprising at least one connection parameter of the remote system;
(c) determining if the at least one connection parameter of the remote system is acceptable based on the at least one first non-security data item of the plurality of non-security data items;
(d) allowing access to the user account based on said determining; and
(e) sending security awareness data for the user account from the communications server, the security awareness data comprising at least one second non-security data item of the plurality of non-security data items.

The embodiments described herein provide in another aspect, a method of controlling access to a user account of a browser-based communications application, the method comprising:
(a) providing a communications server, the communications server configured to access personal information management (PIM) data for the user account, the PIM data comprising at least one non-security data item;
(b) receiving, at the communications server, a connection request from a remote system, the connection request comprising at least one connection parameter of the remote system;
(c) determining if the at least one connection parameter of the remote system is acceptable based on the at least one non-security data item; and
(d) controlling access to the user account based on said determining.

The embodiments described herein provide in a further aspect, a method of providing security awareness data for a user account of a communications application, the method comprising:
(a) providing a communications server, the communications server configured to access personal information management (PIM) data for the user account, the PIM data comprising a plurality of data items;
(b) sending, upon connection, security awareness data from the communications server for a user account, the security awareness data comprising at least one data item from the plurality of data items.

### BRIEF DESCRIPTION OF THE DRAWINGS

Various example embodiments of the present invention will now be described with reference to the drawings, in which:

FIG. 1 is a block diagram of a system for providing security when accessing a user account of a browser-based communications application, in accordance with an embodiment of the present disclosure;

FIG. 2 is a flowchart diagram illustrating the steps of providing security when accessing a user account of a browser-based communications application, in accordance with an embodiment of the present disclosure;

FIGS. 3A and 3B are example screenshots illustrating non-security personal information management (PIM) data that may be accessible to a communications server for a user account;

FIG. 4 is a map illustrating example geographical locations from which a connection to a communications server may be acceptable;

FIG. 5 is a map illustrating example geographical locations on an itinerary accessible to the communications server, from which a connection to the communications server may be acceptable for the time periods corresponding to the geographical locations on the itinerary;

FIG. 6 is a flowchart diagram illustrating the steps of controlling access to a user account of a browser-based application in accordance with another embodiment of the present disclosure, in which a scoring system is used to determine whether a connection parameter is acceptable;

FIG. 7 is an example screenshot of a window presenting security awareness data; and

FIG. 8 is a flowchart diagram illustrating the steps of providing security when accessing a user account of a browser-based communications application, in accordance with an embodiment of the present disclosure.

### DESCRIPTION OF EXEMPLARY EMBODIMENTS

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), at least one input device, and at least one output device. For example and without limitation, the programmable computers may be a personal computer, laptop, personal data assistant, cellular telephone, smart-phone device and wireless device. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The subject system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Moreover, the subject system may be implemented as one or more software components stored on a computer server that is accessible via a client machine in a client-server architecture. In such case, the system can be considered to be a hosted software offering or a software service employed in a software-as-a-service deployment.

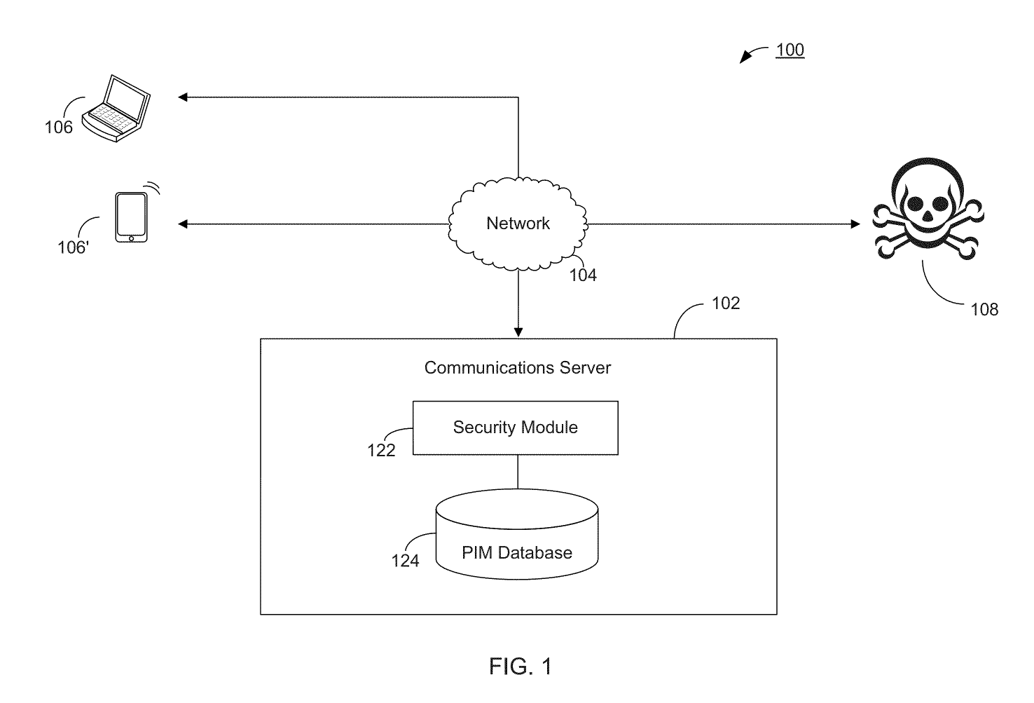

Referring to FIG. 1, a block diagram of a system for providing security when accessing a user account of a browser-based communications application is shown generally as 100. The system 100 includes a communications server 102 and one or more remote systems 106, 106′, each connected to a network 104. While malicious parties 108 do not form part of the system 100, the communications server 102 may be vulnerable to attacks from malicious parties 108.

Communications server 102 may include a server-side application (not shown) that allows users to communicate and coordinate with each other. This application, may allow the communications server 102 to provide email, calendaring, or other functionality related the management of personal information management (PIM) data. The application may store such non-security data for multiple users having user accounts. In an example embodiment, the application may be Microsoft® Exchange™ or Lotus™ Domino™.

The communications server 102 may be configured to provide remote access of such non-security data through a browser-based communications application. In the case where the communications server 102 is running Microsoft® Exchange™ such access may be provided through Microsoft Office Outlook® Web Access or Microsoft Outlook® Web App.

A communications network 104 may be any type of communications network known in the art suitable for conveying an electronic message. In some embodiments, the communications network 104 may be any network, e.g., the Internet, which allows access to the communications server 102 from remote locations outside of a Local Area Network (LAN) that the communications server 102 is operating in.

Remote systems 106, 106′ may be any suitable computer system operable to connect to the network 104. In some embodiments, these systems may be a laptop 106, or a smartphone device 106′ equipped with a network adapter for connecting to the Internet. In some embodiments, the connection request initiated from the remote system 106, 106′ may be initiated from a web browser and directed at the browser-based communications application on the communications server 102.

As discussed above, malicious parties 108 may wish to perform various security attacks on the communications server 102. Malicious parties 108 may typically also be connected to the network 104 when performing security attacks on the communications server 102 and/or remote systems 106, 106′. It will be understood that malicious parties 108 may intercept communications between the communications server 102 and the remote systems 106, 106′, or the server 102 and remote systems 106, 106′ separately.

The communications server 102 may include a security module 122 and a PIM database 124.

The PIM database 124 may store the PIM data for various user accounts. As discussed, the PIM database 124 may include non-security data such as emails, calendar events or other related data. Additional related non-security data items may include an out-of-office status, an on-vacation status, and itinerary information. It will be understood that the communications server 102 may also access non-security data items stored on other servers or databases (not shown) within the internal network in which the communications server 102 is residing. In some embodiments, the itinerary data may be stored on a separate marketing server, or the address book may be stored on a separate Active Directory server.

As discussed below, various non-security data items stored in PIM database 124 or otherwise accessible by the communications server 102 may be used to determine whether a remote system 106, 106′ should be allowed access to the communications server 102.

The security module 122 may be configured to determine whether a remote system 106, 106′ is allowed access to the communications server 102. In doing so, the security module 122 may be configured to perform a method (discussed below) of providing security when accessing a user account of a browser-based communications application. Additionally or alternatively, the security module 122 may be configured to perform a method (discussed below) of controlling access to a user account of a browser-based communications application.

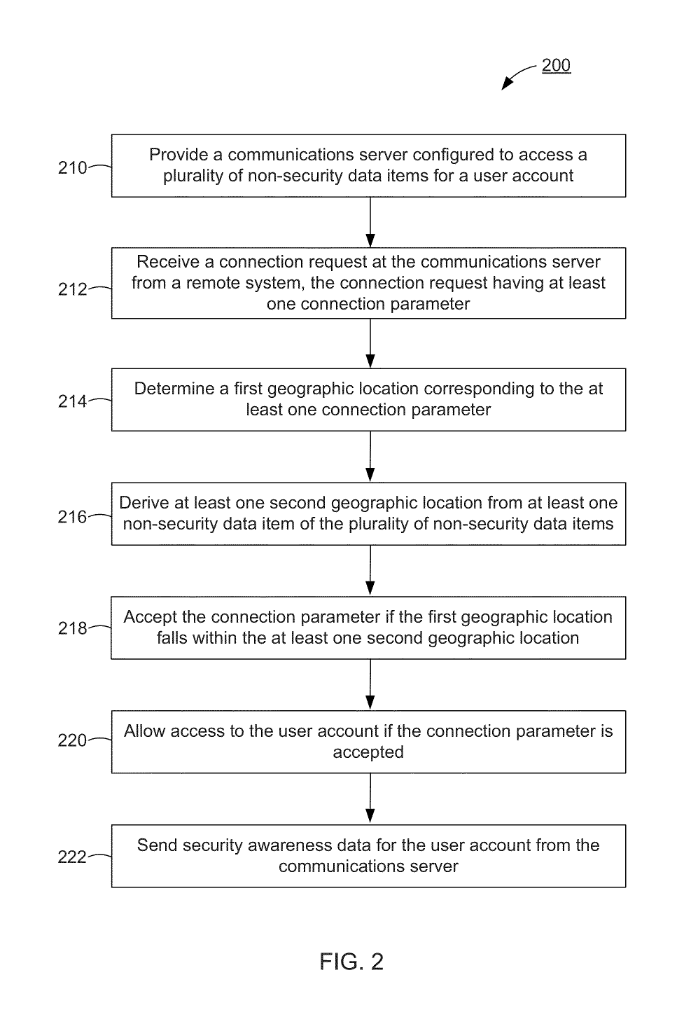

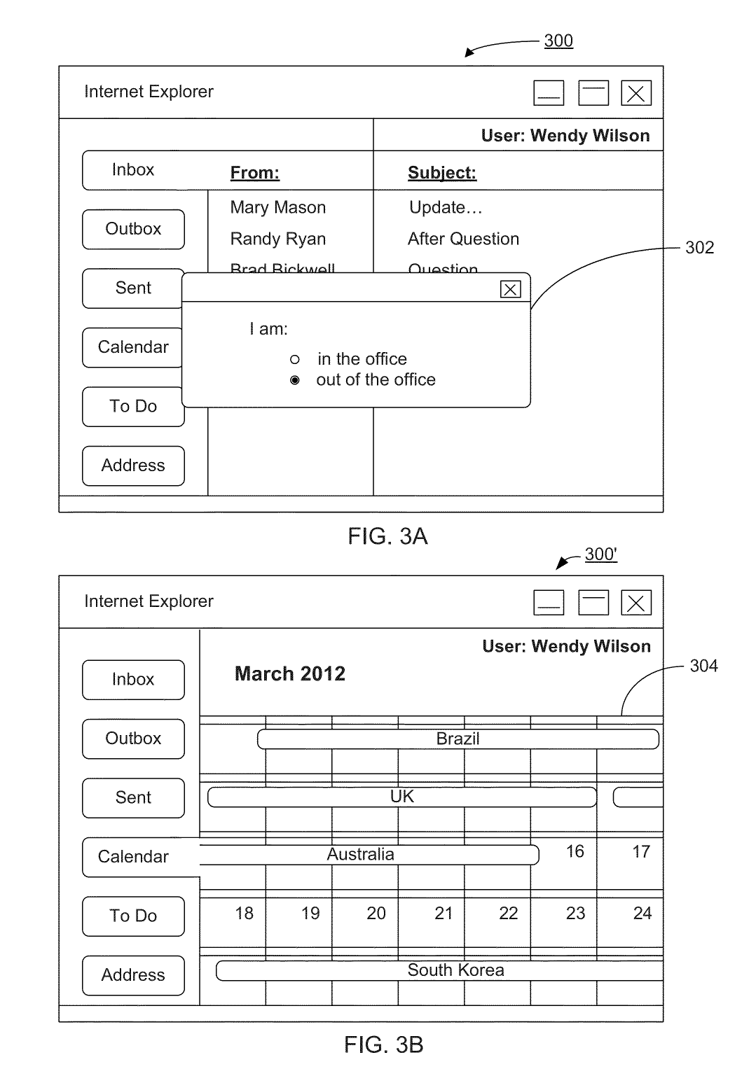

Referring to FIG. 2, illustrated there, generally as 200, is a flowchart diagram showing the steps of providing security when accessing a user account of a browser-based communications application. To illustrate the steps of the method, reference will be made simultaneously to FIGS. 3A, 3B, 4 and 5, which show example scenarios of remote access to the user account for an example user ‘Wendy Wilson’.

At step 210, a communications server 102 can be provided. As discussed, the communications server 102 may have access to a plurality of non-security data items for one or more users.

Referring simultaneously to FIG. 3A, illustrated there generally as 300, is an example screenshot showing PIM data that may be stored on or accessible to communications server 102 for user ‘Wendy Wilson’. The screenshot 300 illustrates various functions that may be available to a user accessing the communications server 102, such functions including: Inbox, Outbox, and Sent Messages folders for email messages, as well as, Calendar, To Do List, and an Address Book. The screenshot 300 illustrates an Inbox being accessed and more particularly, the setting of a travel indicator 302 (e.g., an out-of-office status), in which the user can indicate whether they are in the office or will be out of the office. As discussed below, the traveling indicator is one example non-security data item that may be used to determine if the connection parameter of a remote system 106, 106′ attempting to connect to the communications server 102 is acceptable.

Referring simultaneously also to FIG. 3B, shown there is an alternate example screenshot 300′ showing PIM data that may be stored on or accessible to communications server 102 for the user ‘Wendy Wilson’. As illustrated, the screenshot 300′ shows a calendar 304 depicting an example itinerary for a business trip Wendy Wilson may be taking. Particularly, the itinerary includes a plurality of geographic locations over a plurality of time periods. As shown, in March 2012, Wendy Wilson will be traveling in Brazil during the last few days of February and the first few days of March, in the United Kingdom for a portion of the first week, Australia for a portion for the second week, not traveling for the for the third week, and in South Korea for the last week of the month. As discussed below, the itinerary data may also be used to determine if a connection parameter of a remote system 106, 106′ attempting to connect to the communications server 102 is acceptable.

At step 212, a connection request can be received by the communications server 102 from a remote system 106, 106′. The connection request can include at least one connection parameter to indicate how the remote system 106, 106′ is accessing the communications server 102. In some embodiments, the connection parameter may be an Internet Protocol (IP) address. In other embodiments, the connection parameter may include the organization from which the connection is originating, or an asset tag of the device that is requesting the connection. In further embodiments, the connection parameter can include information about the type of connection used by the remote system 106. For example, a connection parameter may be indicate whether the connection was performed via a wireless network, a mobile phone, or hardwired device.

The security module 122 may then determine if the at least one connection parameter of the remote system is acceptable based on at least one non-security data item stored in or accessible to the communications server 102. In some embodiments, the determining of whether a connection request is acceptable may be performed via steps 214-218.

In various embodiments, a non-security data item can operate in conjunction with a security data item when determining whether a connection request will be accepted. For example, a security data item may indicate that a connection will only be accepted if the connection originates from a mobile device. In such case, the security module 122 can determine that communication requests having a connection parameter that indicates that it was received via a hardwired computer connection will not be accepted. In another embodiment, the security data item can be an indicator requiring a USB key containing identification information for an owner of an account be present to validate the connection parameter before accepting the connection request.

At step 214, the security module 122 can determine a first geographic location corresponding to the at least one connection parameter. In some embodiments, the security module 122 can determine a geographic location from an IP address, according to methods known in the art. The geographic location may reference geographies of various sizes, such as a country, region, state, or city.

At step 216, the security module 122 can derive at least one second geographic location from the at least one non-security data item stored on or accessible to the communications server 102. For example, the security module 122 can determine the second geographic location from a traveling indicator (e.g., an out-of-office status), on-vacation status or itinerary information.

At step 218, the security module 122 can accept the connection parameter of the remote system 106, 106′ if the first geographical location falls within the at least one second geographic location.

In some embodiments, the communications server 102 may store one or more lists containing preset second geographical locations from which (i) connections would be accepted, or (ii) connections would be rejected. Examples of connections which would be accepted may include a typical computing location of the holder of the user account. A typical computing location may include a home office location, a work office location, a client location, or a short term assignment location. Examples of connections which would be rejected may include categories of institutions (e.g., universities) from which connection requests are frequently malicious. Such lists may be maintained by an organization's Information Technology (IT) personnel.

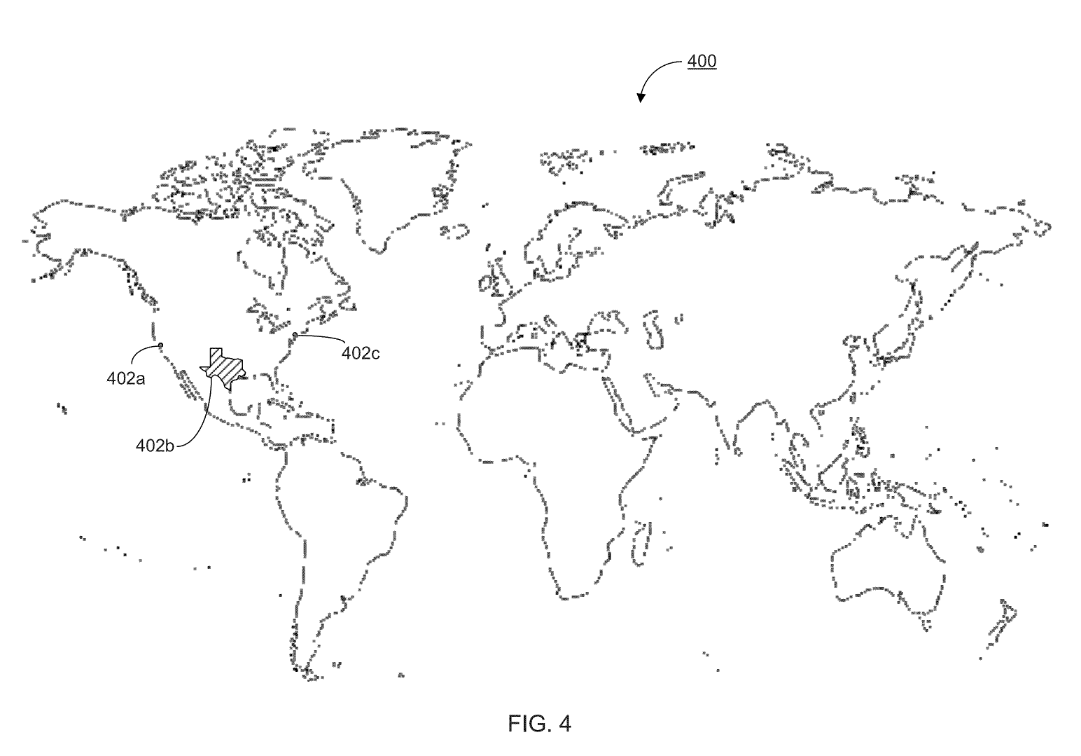

Referring simultaneously to FIG. 4, shown there generally as 400, is a map illustrating example second geographical locations from which a connection to a communications server 102 may be acceptable. Continuing on with the example with user Wendy Wilson, the shown geographic locations may correspond to typical computing locations for Wendy Wilson. This list may include locations for which Wendy Wilson's organization has offices, i.e., San Francisco 402a, Texas 402b and New York City 402c. The security module 122 can then determine that a request having a connection parameter indicating it is being received from inside the San Francisco area 402a, the Texas area 402b, and the New York City area 402c would be acceptable. If the connection parameter corresponds to a location outside these areas, the connection parameter would be determined to be not acceptable. In various embodiments, the second geographic locations may be determined to be much smaller, and just derived to be a radius from the exact office locations within each city or state.

In another embodiment, the non-security data item may include a travel indicator indicating that the holder of the user account is traveling, and that the second geographic location may be a location outside that of the typical computing locations for a user. In some embodiments, the travel indicator may be an out-of-office status. For example, in relation to FIG. 4, connection requests from outside San Francisco 402a, Texas 402b and New York City 402c would not be accepted for Wendy Wilson's account if the out-of-office status is set to being in the office; but if the out-of-office status is set to indicate that Wendy will be out of the office, connections from outside those San Francisco 402a, Texas 402b and New York City 402c may be accepted.

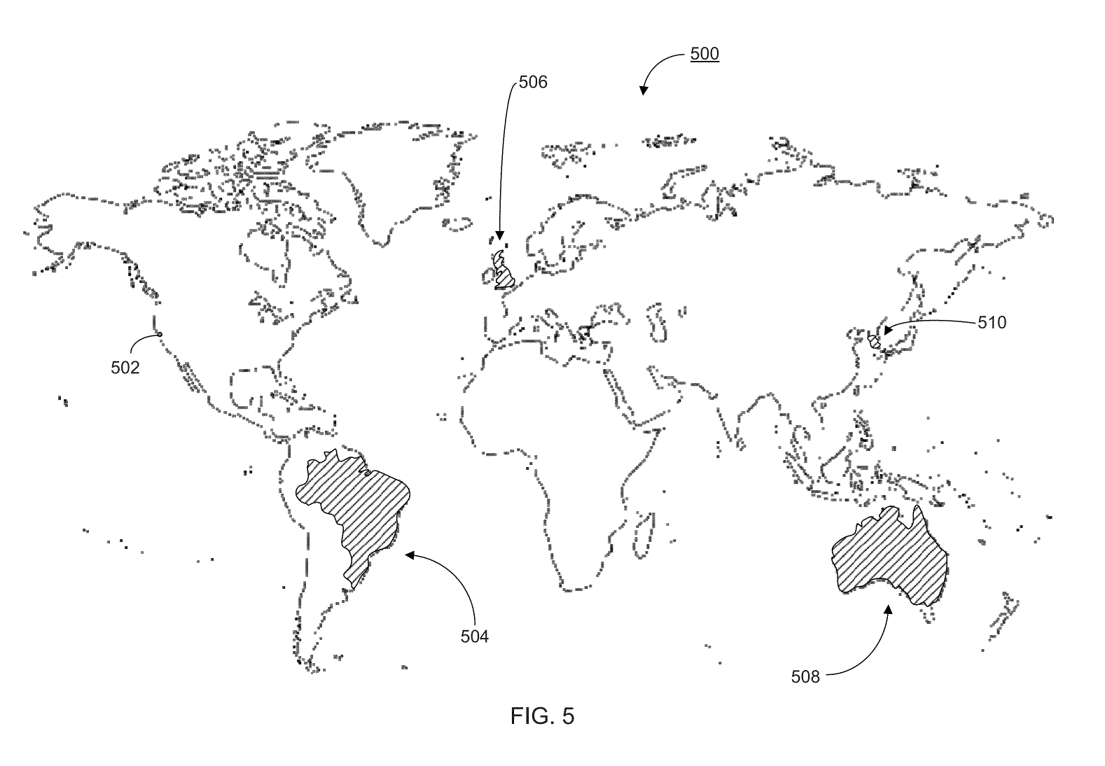

Referring now to FIG. 5, shown generally as 500, is another example map illustrating geographical locations from which a connection to a communications server 102 may be acceptable. In such example, the security module 122 can take the information indicated in the example travel itinerary shown in FIG. 3B to determine one or more second geographic locations.

For example, security module 122 can determine that communication requests received from a connection parameter (e.g., IP addresses) corresponding to Brazilian locations 504 for Wendy Wilson's account will be acceptable for the last few days of February 2012 and the first few days of March 2012. Similarly, security module 122 can determine that communication requests received from IP addresses in the United Kingdom 506, Australia 508, and Korea 510 will be acceptable for the corresponding period of time indicated in the travel itinerary, i.e., a portion of the first week, a portion of the second week, and a portion of the last week of March 2012 respectively. Security module 122 can determine that access from outside the acceptable areas during the corresponding period of time will be denied.

In some embodiments, where the owner of a user account is not scheduled to be traveling to any particular location, security module 122 can determine that only requests from IP addresses within the home location, as exemplified by San Francisco 502 are acceptable.

In certain embodiments, where non-security data items includes an on-vacation status, security module 122 can determine that communication requests received during the vacation time period will not be acceptable from any first geographic location and that access may only be allowed if the remote system 106, 106′ is accessing the communications server from inside the organization's internal network. In such case, no second geographic locations may be derived.

These embodiments may be advantageous in ensuring that malicious parties 108 are not allowed access to a user account on communications server 102. Particularly, by not accepting connection requests from geographic locations without an indication that such request is likely to be legitimate; there is a reduced chance of a man in the middle or replay attack being successful. At the same time, legitimate connection requests from a user to access his or her account (as determined by reference to a non-security data item) can be allowed through when appropriate.

Additionally or alternatively, the second geographic location may be derived in view of the connection parameter. For example, if the connection parameter includes information about an office (e.g., a client site) from which the user is connecting, the second geographic location may be derived to be a radial distance from the non-security data item indicating the location of that office accessed by or stored on the communications server 102.

At step 220, the security module 122 allows access to a user account where the connection parameter is accepted.

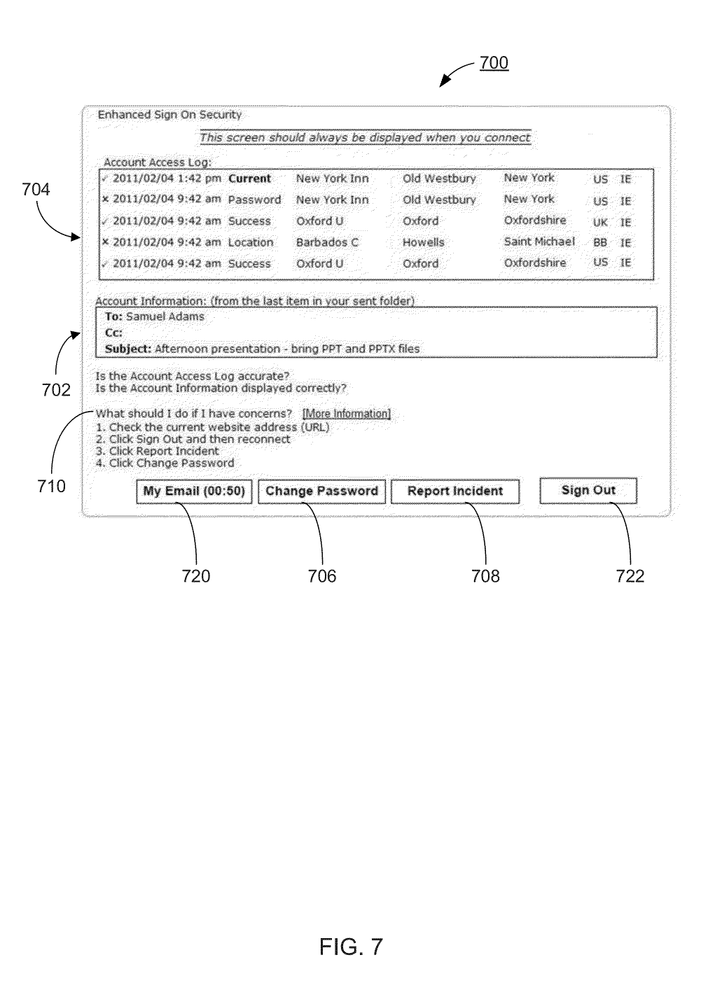

At step 222, the security module 122 can send security awareness data for the user account from the communications server 102, as illustrated, for example, in FIG. 7 (discussed below).

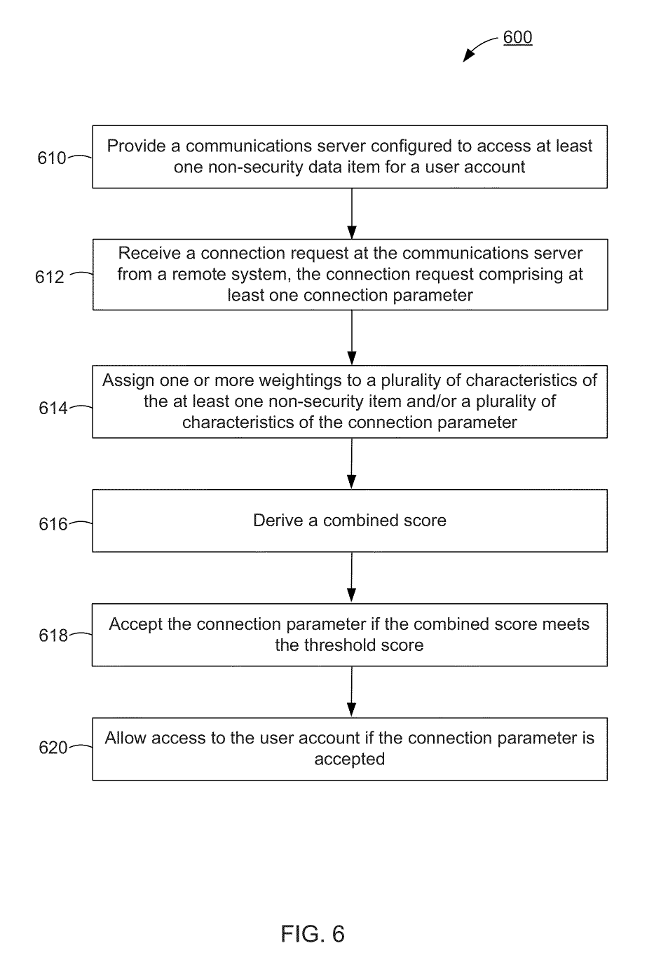

Referring now to FIG. 6, shown generally as 600, is a flowchart diagram illustrating the steps of controlling access to a user account of a browser-based application in accordance with another embodiment of the present disclosure. In this embodiment, a scoring system is used to determine whether a connection parameter of a remote system is acceptable. It will be understood that the scoring system may be used in addition or alternative to the determining steps discussed with respect to FIG. 2.

At step 610, a communications server 102 is provided. The communication server 102 may be similar in nature to that which was described above.

At step 612, a connection request is received by the communications server 102 from a remote system 106, 106′. The connection request comprises at least one connection parameter. The at least one connection parameter may be similar to those discussed with respect to the flowchart illustrated in FIG. 2.

At step 614, the security module 122 can assign one or more weightings to a plurality of characteristics of the connection parameter and/or a plurality of characteristics of at least one non-security item. In certain embodiments, the one or more weightings are combinable to form a threshold score.

In one example, such weightings may include various positive or negative numbers that are summed to produce a combined score. These numbers may be assigned to characteristics of the non-security data items (e.g., +1 may be assigned to the presence of an out-of-office status indicating a user is out of the office) or characteristics of the connection parameter (e.g., −2 may be assigned to an attempted connection from a country that is not on a user's account acceptable list, and +5 may be assigned if a user is connecting from a computer with an asset tag from the user organization's IT department). A threshold minimum score may be determined by an organization's IT department to be +3 before a connection from a remote system 106, 106′ would be allowed.

In another example, the combined score may be calculated using a mathematical formula. For example, a formula includes summing up the geographical factors and giving them a 40% weight and then separately summing up the combined score history (discussed below) and giving them a 60% weight to arrive at a combined score.

It should be understood that such weightings can be configured depending on various factors, and that the minimum score may also similarly be configured. For example, these factors may include the security threat perceived by an organization, or the habits of the owner for a user account. With regards to the habits of a user, if a user often travels on last minute business development trips to exotic locations, an IT department give a low weighting to the country from which a connection request is originating, and give a high weighting to the presence of an asset tag in the connection request identifying the connecting device as one owned by the organization.

At step 616, security module 122 derives a combined score. In some embodiments, security module 122 derives the combined score for the connection parameter of the remote system 106. In other embodiments, security module 122 derives a combined score for the connection parameter based on the association of the connection parameter to the characteristics of the at least one non-security item. In the example, the combined score is determined from both characteristics of the connection parameter and a non-security data item—combining the three scores (+1 −2 +5), we arrive at a combined score of +4.

At step 618, the security module 122 accepts the connection parameter if the combined score meets the threshold score. In the example, the combined score is +4, which meets the minimum positive threshold score of +3, and the connection parameter is accepted.

At step 620, the security module 122 allows access to the user account because the connection parameter is accepted.

In some embodiments, the derived combined score may be stored on the communications server 102 so that the communications server 102 may keep track of the combined score history. As discussed above, this history may then be used when deriving the combined score in future connection attempts to determine whether a connection request is allowed. For example, if the score history shows that the derived score is trending downwards, the security module 122 may be configured to deny access before the combined score drops below the threshold to forestall any possibility of a security breach.

Reference is now made to FIG. 7, in which an example screenshot of a warning window presenting security awareness data is shown generally as 700. Security awareness data can be shown to a user after their connection request has been allowed. In some embodiments, it may be shown immediately after login, but before the full functionality of the applications running on the communications server 102 is provided to the user.

Example screenshot 700 includes security awareness data for a user account stored on, and accessible from, the communications server 102. Security awareness data may include any data item within the internal network of the communications server 102 that is typically accessible only from the communications server 102.

Example security awareness data may include recently sent email messages 702, recently received email messages (not shown), upcoming calendar events (not shown), and a connection history 704 for the user account. Additionally or alternatively, security awareness data may be the subject line information of a number of previously sent email messages from the account. Further security awareness data may include information from a directory server or service (e.g., Active Directory) accessible form the communications server 102. In such embodiment, security awareness data may include the users' full name, address, and/or human resource (HR) details.

Providing security awareness data from data items that is typically only accessible to the communications server 102 helps to provide assurance to the user that they are accessing the intended server. For example, while a phishing server may be able to replicate the login screen and perhaps, even some of the information stored on the communications server 102 (e.g., as may have been stolen through a screen scraper), more detailed security awareness data will likely not be available to the phishing server (e.g., a phishing server typically does not have access to an directory server inside the internal network in which the communications server 102 is residing). As such, the user will be able to identify if any information is incorrect or incomplete in the security awareness data so as to be alerted to a security breach.

In an embodiment where the security awareness data includes connection history 704, the connection history 704 may include past attempts to access the user account. Such history may include both successful and failed attempts (failed attempts being illustrated with an ‘X’, and a successful attempt being illustrated with a ‘✓’). In certain embodiments, the connection history 704 may also include the date, time, or geographic location (e.g., state or country) of a number of previous access attempts. Moreover, the connection history 704 may further show the type of browser that the previous connection attempt was performed with. In some embodiments, a score history, or a version of it, may be displayed as part of the security awareness data. For example, a score history may be displayed in a graphical form that illustrates a trend in the score.

Such connection history 704 data may help to identify additional potential malicious party 108 attacks. A user may be able to see in the connection history 704 that a country that he has not recently visited has attempted to access his/her account, thereby raising his/her awareness that the account may be subject to a security risk. Moreover, the connection history 704 may alert a user to a Man in the Middle attack. That is, if a user sees in the security awareness data that his/her connection is originating from a country where they do not to be accurate (e.g., if the security awareness data shows the connection is originating from Russia when the user is physically located in the United States), then this would alert the user that they are likely the subject of a Man in the Middle attack.

After being made aware of such security problems, a user may be presented with various options 710 to address the concern. One such option may include checking the current website address (URL) to ensure that the URL has not been mimicked by a phishing server.

Another option may be to change their password 706. A user would select the change password option 706 where the user believes that their password has been compromised, and would like to prevent further unauthorized access.

A further option may be to report an incident 708 to IT personnel so that they can investigate further into the problem. This may be the case if a failed access has been attempted, and the user may wish to flag such activity to IT personnel.

In addition, a user may wish to select the sign out option 722 and not use the potentially compromised user account any more until they can be assured that security has been restored.

If a user does not see any potential security problems on the warning window, they may proceed to access the communications application by selecting the My Email 720 option. This option may be selected by default after an automatic timeout; i.e. the security module 122 may presume that if the user has not selected any of the security awareness options, that it is safe for the user to proceed to use the application on the communications server 102.

In a further embodiment, the warning window 700 may provide information presented to a user regarding other non-security data or connection parameters. This information presented to the user can be highlighted, colour coded, or otherwise marked for the user to aid in identifying atypical connections.

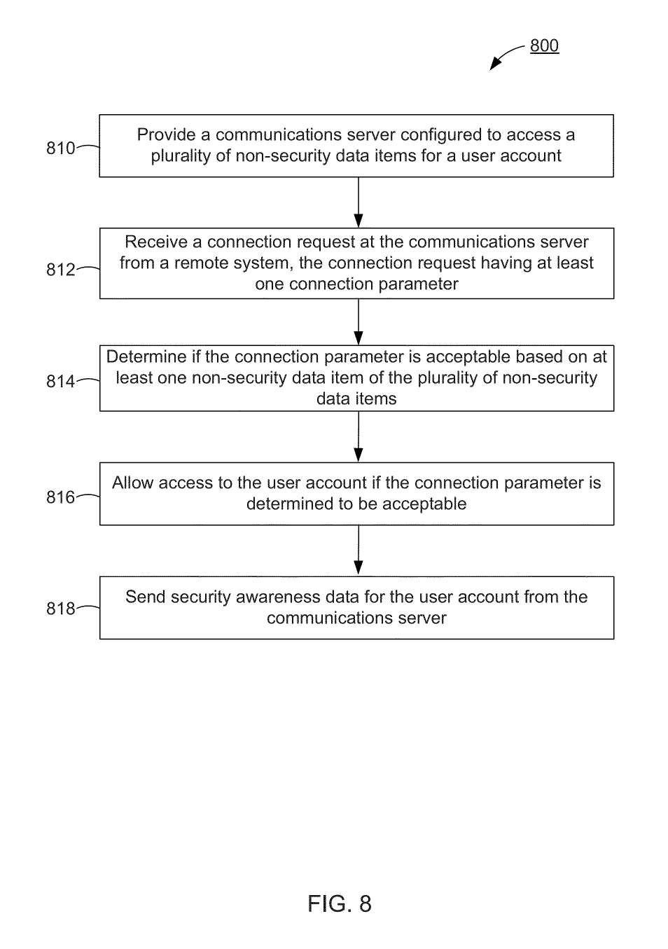

Referring to FIG. 8, shown generally as 800 is a flowchart diagram illustrating the steps of providing security when accessing a user account of a browser-based communications application. FIG. 8 shows more generally the steps of the flowchart diagram illustrated in FIG. 2, and some steps of FIG. 2 may be analogous to the steps in FIG. 8. Particularly, steps 810 and 812 may be performed similarly to steps 210 and 212 respectively, and steps 816 and 818 may be performed similarly to steps 220 and 222 respectively. Step 814 discusses a step of determining if the connection parameter is acceptable based on at least one non-security data item. This is a general step, for which a specific implementation is provided in steps 214-216.

While the above description provides examples of the embodiments, it will be appreciated that some features and/or functions of the described embodiments are susceptible to modification without departing from the spirit and principles of operation of the described embodiments. For example, the steps of a method in accordance with any of the embodiments described herein may be performed in any order, whether or not such steps are described in the claims, figures or otherwise in any sequential numbered or lettered manner.

Accordingly, what has been described above has been intended to be illustrative of the invention and non-limiting and it will be understood by persons skilled in the art that other variants and modifications may be made without departing from the scope of the invention as defined in the claims appended hereto.

We claim:

1. A method of providing security when accessing a user account of a browser-based communications application, the method comprising:
(a) providing a communications server, the communications server configured to access personal information management (PIM) data for the user account, the PIM data comprising a plurality of non-security data items;
(b) receiving, at the communications server, a connection request from a remote system, the connection request comprising at least one connection parameter of the remote system;
(c) determining if the at least one connection parameter of the remote system is acceptable based on at least one first non-security data item of the plurality of non-security data items;
(d) allowing access to the user account based on said determining; and
(e) sending security awareness data for the user account from the communications server, the security awareness data comprising at least one second non-security data item of the plurality of non-security data items.

2. A method of controlling access to a user account of a browser-based communications application, the method comprising:
(a) providing a communications server, the communications server configured to access personal information management (PIM) data for the user account, the PIM data comprising at least one non-security data item;
(b) receiving, at the communications server, a connection request from a remote system, the connection request comprising at least one connection parameter of the remote system;
(c) determining if the at least one connection parameter of the remote system is acceptable based on the at least one non-security data item; and
(d) controlling access to the user account based on said determining.

3. The method of claim 2, wherein the connection parameter corresponds to a first geographic location.

4. The method of claim 3, wherein at least one second geographic location is derivable from the at least one non-security data item, and said determining comprises accepting the connection parameter if the first geographical location falls within the at least one second geographic location.

5. The method of claim 4, wherein the second geographic location comprises a radius from a typical computing location of the holder of the user account.

6. The method of claim 5, wherein the typical computing location comprises one selected from the group consisting of: a home office location, a work office location, a client location, and a short term assignment location.

7. The method of claim 5, wherein the at least one non-security data item comprises a traveling indicator for indicating that the holder the user account is traveling, and the second geographic location is derivable to be a location outside of the typical computing location.

8. The method of claim 7, wherein the traveling indicator is an out-of-office status.

9. The method of claim 4, wherein the at least one non-security data item comprises an on-vacation status, and the connection parameter is not acceptable from any first geographic location if the on-vacation status is turned on.

10. The method of claim 3, wherein the at least one non-security data item comprises an itinerary, the itinerary comprising a plurality of geographic locations for a plurality of time periods, wherein when receiving the connection request during a time period of the itinerary, said determining comprises accepting the connection parameter if the first geographic indicator corresponding to the connection parameter falls within the geographic location for said time period.

11. The method of claim 3, wherein the connection parameter comprises an Internet Protocol (IP) address, said IP address corresponding to the first geographic location.

12. The method of claim 3, wherein the geographical location is operable to indicate at least one selected from the group consisting of: country, region, state and city.

13. The method of claim 2, wherein the PIM data comprises email messages.

14. The method of claim 2, wherein said determining comprises:
(a) assigning one or more weightings to a plurality of characteristics of the connection parameter, the one or more weightings being combinable to form a threshold score;
(b) deriving a combined score for the connection parameter of the remote system; and
(c) accepting the connection parameter if the combined score meets the threshold score.

15. The method of claim 2, wherein said determining comprises:
(a) assigning one or more weightings to a plurality of characteristics of the at least one non-security data item, the one or more weightings being combinable to form a threshold score;
(b) deriving a combined score for the connection parameter of the remote system based the association of the connection parameter to the characteristics of the at least one non-security data item; and
(c) accepting the connection parameter if the combined score meets the threshold score.

16. The method of claim 2, wherein said determining comprises:
(a) assigning one or more weightings to a plurality of characteristics of the connection parameter and the at least one non-security data item, the one or more weightings being combinable to form a threshold score;
(b) deriving a combined score for the connection parameter of the remote system based on the connection parameter and the association of the connection parameter to the characteristics of the at least one non-security data item; and
(c) accepting the connection parameter if the combined score meets the threshold score.

17. A method of providing security awareness data for a user account of a communications application, the method comprising:
(a) providing a communications server, the communications server configured to access personal information management (PIM) data for the user account, the PIM data comprising a plurality of data items; and
(b) sending, upon connection, security awareness data from the communications server for a user account, the security awareness data comprising at least one data item from the plurality of data items.

18. The method of claim 17, wherein the at least one data item is selected from the group consisting of:
(i) recently sent email messages,
(ii) recently received email messages,
(iii) upcoming calendar events,
(iv) address book contacts,
(v) a connection history for the user account and
(vi) where a score is used to determine whether the communications server is accessible, a score history for the user account.

19. The method of claim 18, wherein the connection history comprises past failed attempts to access the user account.

20. The method of claim 17, wherein the PIM data is stored on the communications server.

21. The method of claim 17, wherein the PIM data is stored on a separate server accessible from the communications server.

22. A system for providing security when accessing a user account of a browser-based communications application, the system comprising:
one or more memories for storing information and at least one set of instructions, and
one or more processors configured to:
(a) providing a communications server, the communications server configured to access personal information management (PIM) data for the user account, the PIM data comprising a plurality of non-security data items;
(b) receiving, at the communications server, a connection request from a remote system, the connection request comprising at least one connection parameter of the remote system;
(c) determining if the at least one connection parameter of the remote system is acceptable based on at least one first non-security data item of the plurality of non-security data items;
(d) allowing access to the user account based on said determining; and
(e) sending security awareness data for the user account from the communications server, the security awareness data comprising at least one second non-security data item of the plurality of non-security data items.
